(19) United States
(12) Patent Application Publication
(10) Pub. No.: US 2026/0253947 A1
(43) Pub. Date: Aug. 27, 2026

(54) LITHIUM ION CONDUCTIVE GLASS MATERIAL

(71) Applicant: OHARA INC., Sagamihara-shi, Kanagawa (JP)

(72) Inventors: Kazuhito Ogasa, Sagamihara-shi (JP); Chie Yamaguchi, Sagamihara-shi (JP)

(73) Assignee: OHARA INC., Sagamihara-shi, Kanagawa (JP)

(21) Appl. No.: 18/875,916

(22) PCT Filed: Jun. 15, 2023
(86) PCT No.: PCT/JP2023/022259

§ 371 Date: Dec. 17, 2024

(30) Foreign Application Priority Data
Jun. 21, 2022 (JP) 2022-099569

(51) Int. Cl. H01M 10/0562; C03C 4/18; C03C 10/00; H01M 10/0525

(52) U.S. Cl. CPC H01M 10/0562; C03C 4/18; C03C 10/00; H01M 10/0525; H01M 2300/0068

(57) ABSTRACT

There is provided a lithium ion conductive glass material from which a solid electrolyte having both a high density and a high lithium ion conductivity can be formed by mixing and sintering with a lithium ion conductive material at 700° C. or lower. Then, the above problem is solved by a lithium ion conductive glass material containing, in mole percent on an oxide basis, 43.5 to 49.0% of a P₂O₅ component, 0.5 to 4.0% of an Al₂O₃ component, and 47.0 to 55.0% of a Li₂O component.

### TECHNICAL FIELD

The present invention relates to a lithium ion conductive glass material, a solid electrolyte material containing the same, or an electrode active material having a covering glass layer formed by coverage with the same, an all-solid-state secondary battery having a member in which materials including this solid electrolyte material are sintered, and others.

### BACKGROUND ART

Chargeable and dischargeable lithium ion secondary batteries with high energy density are widely used in applications such as power supplies for electric vehicles and power supplies for cell phone terminals.

Most lithium ion secondary batteries currently on the market use liquid electrolyte (electrolytic solution) to ensure that they have a high energy density. A material prepared by dissolving lithium salt in a non-protic organic solvent such as carbonate ester or cyclic ester is usually used as the electrolytic solution.

However, in lithium ion secondary batteries using liquid electrolyte (electrolytic solution) (liquid-based lithium ion secondary batteries), there is a risk of electrolyte leakage. In addition, organic solvents and other materials commonly used in electrolytic solution are volatile and flammable substances, and the problem is that the substances are undesirable from a safety standpoint.

Thus, it has been proposed to use a solid electrolyte as the electrolyte of a lithium ion secondary battery instead of liquid electrolyte (electrolytic solution) such as an organic solvent. In addition, development of all-solid-state secondary batteries, in which solid electrolyte is used as the electrolyte and all other components such as the electrode layer are also composed of solid, is underway.

Typical properties required for solid electrolyte for all-solid-state secondary batteries include lithium ion conductivity and sintering properties. It is also required that the density is at or above a certain level for good interface formation with the electrode layers (positive electrode layer and negative electrode layer), good interface formation between materials other than solid electrolyte materials such as electrode active materials and the solid electrolyte materials, and good interface formation among solid electrolyte materials themselves in the electrode layers or in the solid electrolyte layer.

As a solid electrolyte for all-solid-state secondary batteries, for example, a glass-ceramic electrolyte with a composition of Li₁₊ₓAlₓTi₂₋ₓP₃O₁₂ plus AlPO₄ disclosed in Non-Patent Document 1 has been considered. Attempts have also been made to improve sintering properties by mixing lithium ion conductive glass with ceramic electrolytes to enable sintering at low temperature, as disclosed in Non-Patent Document 2, Non-Patent Document 3, and Patent Document 1.

As for lithium ion conductive glass materials themselves, Li₂O—SiO₂, Li₄SiO₄—Li₃BO₃, Li₂O—SiO₂—B₂O₃, Li₂O—SiO₂—ZrO₂, and others have been considered as shown in Non-Patent Document 4, and the Li₂O content is known to contribute to lithium ion conductivity. In recent years, as a solid electrolyte for all-solid-state secondary batteries, consideration has been made to increase water resistance by fixing the Li₂O content in Li₂O—Al₂O₃—P₂O₅ glass to 50 mol % and increasing the Al₂O₃ content, as disclosed in Non-Patent Document 5. Similarly, as disclosed in Patent Document 2, there has also been consideration of adding a Zro, component, an Y₂O₃ component, a CeO₂ component, and other components to Li₂O—Al₂O₃—P₂O₅ glass, thereby increasing water resistance and other properties.

### CITATION LIST

### Patent Documents

PATENT DOCUMENT 1: Japanese Patent Laid-Open No. 2012-209256
PATENT DOCUMENT 2: Japanese Patent Laid-Open No. 2015-153588

### Non-Patent Documents

NON-PATENT DOCUMENT 1: J. Am. Ceram. Soc. 80 (1997) 1901-1903
NON-PATENT DOCUMENT 2: Journal of Solid State Chemistry 265 (2018) 381-386
NON-PATENT DOCUMENT 3: Solid State Ionics 47 (1991) 257-264
NON-PATENT DOCUMENT 4: Functional Chemistry of Electrons and Ions Series Vol. 3 Next Generation Lithium Secondary Battery ISBN 4-86043-023-9 C3043 P276-280
NON-PATENT DOCUMENT 5: Journal of Non-crystalline Solids 430 (2015) 64-72

### SUMMARY OF THE INVENTION

### Problem to be Solved by the Invention

Here, the glass ceramic electrolyte disclosed in Non-Patent Document 1 is reported to have a lithium ion conductivity of 1×10⁻³ S/cm at 25° C. However, the sintering temperature during synthesis is very high, and is 1,000° C. or higher. Furthermore, after synthesis, when performing re-sintering with the electrode material, a sintering temperature of 900° C. or higher is required to maintain the lithium ion conductivity at 25° C. at about 1×10⁻⁴ S/cm, and decomposition of the electrode active material (positive electrode active material or negative electrode active material) due to sintering at high temperature becomes a problem.

Meanwhile, ceramic electrolytes disclosed in Non-Patent Documents 2 and 3 have low intragranular resistance (resistance to ion conduction occurring within particles) but high grain boundary resistance (resistance to ion conduction occurring at the contact interface between particles), and thus achieving high lithium ion conductivity is difficult. Therefore, lithium salt such as Li₃PO₄ and Li₃BO₃ or lithium ion conductive glass such as Li₃BO₃ glass is mixed with the ceramic electrolytes, and sintered to reduce the grain boundary resistance and increase lithium ion conductivity. Even in this case, however, the sintering temperature required to obtain a lithium ion conductivity of about 1×10⁻⁴ S/cm is quite high at 900° C.

Furthermore, Patent Document 1 discloses an all-solid-state secondary battery in which two types of solid electrolytes are mixed, and a solid electrolyte using a Li₂O—P₂O₅-based lithium ion conductive glass material is disclosed in that document. Although its sintering temperature is as low as 600° C., it is not mass producible due to the need to pressurize the material at high temperature.

In addition, Patent Document 2 discloses that the containment of one or more selected from an Y₂O₃ component, a Sc₂O₃ component, a ZrO component, a CeO₂ Component, and a Sm₂O₃ component in Li₂O—P₂O₅—Al₂O₃ glass improves water resistance and increases the discharge capacity of all-solid-state secondary batteries. However, even though the sintering temperature in this case is also as low as 600° C., the need to pressurize the material at high temperature similarly makes mass production difficult.

It is known that, as a method with high mass productivity, sintering after sheet forming, stacking, cutting, and degreasing in the form of a multilayer ceramic capacitor is preferred, but sintering at 700° C. or lower is required to suppress diffusion of the material (Journal of Power Sources 192 (2009) 689-692).

Accordingly, an object of the present invention is to provide a lithium ion conductive glass material from which a solid electrolyte having both a high density and a high lithium ion conductivity can be formed by mixing and sintering with a lithium ion conductive material at 700° C. or lower.

### Means for Solving the Problem

The present inventors have conducted intensive studies to solve the above problem, and have found that a lithium ion conductive glass material containing, in mole percent on an oxide basis, 43.5 to 49.0% of a P₂O₅ component, 0.5 to 4.0% of an Al₂O₃ component, and 47.0 to 55.0% of a Li₂O component serves as a sintering auxiliary that can form a solid electrolyte having both a high density and a high lithium ion conductivity by mixing and sintering with a lithium ion conductive material at 700° C. or lower. In addition, it has also been found that this lithium ion conductive glass material is useful as a material to cover the surface of electrode active materials.

That is, the present invention includes the following <1> to <7>,

<1> A lithium ion conductive glass material containing, in mole percent on an oxide basis, 43.5 to 49.0% of a P₂O₅ component, 0.5 to 4.0% of an Al₂O₃ component, and 47.0 to 55.0% of a Li₂O component.
<2> The lithium ion conductive glass material according to <1>, satisfying at least two or more selected from the group consisting of (1), (2), and (3) below, and having a lithium ion conductivity of not less than 5.0×10⁻⁹ S/cm and not more than 5.0×10⁻⁸ S/cm at 25° C. in a vitreous state:
(1) a crystallization temperature (Tc) is equal to or higher than 400° C. and equal to or lower than 460° C.;
(2) a glass transition point (Tg) is equal to or higher than 330° C. and equal to or lower than 365° C.; and
(3) a melt initiation temperature (mp) is equal to or higher than 560° C. and equal to or lower than 590° C.
<3> The lithium ion conductive glass material according to <1> or <2>, which is a sintering auxiliary used for mixing and sintering with a lithium ion conductive material including a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi₂₋ₓSi_{y}P_{3-y}O₁₂ (0.7>x≥0.05, 0.5>y≥0), and is a powder with a maximum particle size of 200 μm or less and an average particle size (D₅₀) of 100 μm or less.
<4> A solid electrolyte material formed by mixing the lithium ion conductive glass material according to any one of <1> to <3> and a lithium ion conductive material including a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi₂₋ₓSi_{y}P_{3-y}O₁₂ (0.7>x≥0.05, 0.5>y≥0).
<5> An all-solid-state secondary battery, including a member integrally molded by sintering materials including the solid electrolyte material according to <4>, and a positive electrode material or negative electrode material.
<6> An electrode active material (positive electrode active material or negative electrode active material) including a covering glass layer formed by performing a covering treatment with the lithium ion conductive glass material according to <1> or <2> on a surface, wherein a coverage ratio of the covering glass layer on this surface is 18% or more.
<7> A lithium ion secondary battery (all-solid-state secondary battery or liquid-based lithium ion secondary battery using liquid electrolyte) including the electrode active material according to <6>.

### Effect of the Invention

The present invention can provide a lithium ion conductive glass material from which a solid electrolyte having both a high density and a high lithium ion conductivity can be formed by mixing and sintering with a lithium ion conductive material at 700° C. or lower. This can also be suitably used as a covering glass layer that covers the surface of electrode active materials.

### BRIEF DESCRIPTION OF THE DRAWINGS

FIG. 1 is a flow chart illustrating the synthesis of the lithium ion conductive glass materials (Step 1) and solid electrolytes (Step 2) of Examples and Comparative Examples;

FIG. 2 is a graph showing the relationship between the P₂O₅ content (mol %) and the Li₂O content (mol %) in the lithium ion conductive glass materials of Examples and Comparative Examples;

FIG. 3 is a graph showing the relationship between the Al₂O₃ content (mol %) and the Li₂O content (mol %) in the lithium ion conductive glass materials of Examples and Comparative Examples;

FIG. 4 is a graph showing the relationship between the Li₂O content (mol %) in the lithium ion conductive glass materials of Examples and Comparative Examples and their lithium ion conductivity (ion conductivity of glass);

FIG. 5 is a graph showing the relationship between the crystallization temperature (Tc) and the melt initiation temperature (mp) in the lithium ion conductive glass materials of Examples and Comparative Examples;

FIG. 6 is a graph showing the relationship between the crystallization temperature (Tc) and the glass transition point (Tg) in the lithium ion conductive glass materials of Examples and Comparative Examples;

FIG. 7 is a graph showing the relationship between the lithium ion conductivity (ion conductivity) and density in the sintered pellets of Examples and Comparative Examples;

FIG. 8 is a graph showing the relationship between the P₂O₅ content (mol %) of the lithium ion conductive glass materials used to prepare the sintered pellets of Examples and Comparative Examples and the density of the sintered pellets;

FIG. 9 is a graph showing the relationship between the Li₂O content (mol %) of the lithium ion conductive glass materials used to prepare the sintered pellets of Examples and Comparative Examples and the density of the sintered pellets;

FIG. 10 is a graph showing the relationship between the lithium ion conductivity of the lithium ion conductive glass materials used to prepare the sintered pellets of Examples and Comparative Examples (ion conductivity of glass) and the density of the sintered pellets;

FIG. 11 is a secondary electron image (an image substituting drawing) of a broken-out section for the sintered pellets of Examples and Comparative Examples obtained by sintering at 700° C.;

FIG. 12 is a graph showing the relationship between the Al₂O₃ content (mol %) of the lithium ion conductive glass materials used to prepare the sintered pellets of Examples and Comparative Examples and the lithium ion conductivity (ion conductivity) of the sintered pellets;

FIG. 13 is a graph showing the relationship between the lithium ion conductivity of the lithium ion conductive glass materials used to prepare the sintered pellets of Examples and Comparative Examples (ion conductivity of glass) and the lithium ion conductivity (ion conductivity) of the sintered pellets;

FIG. 14 is a graph showing the relationship between the glass transition point (Tg) of the lithium ion conductive glass materials used to prepare the sintered pellets of Examples and Comparative Examples and the lithium ion conductivity (ion conductivity) and density of the sintered pellets;

FIG. 15 is a graph showing the relationship between the crystallization temperature (Tc) of the lithium ion conductive glass materials used to prepare the sintered pellets of Examples and Comparative Examples and the lithium ion conductivity (ion conductivity) and density of the sintered pellets; and

FIG. 16 is a graph showing the relationship between the melt initiation temperature (mp) of the lithium ion conductive glass materials used to prepare the sintered pellets of Examples and Comparative Examples and the lithium ion conductivity (ion conductivity) and density of the sintered pellets.

### DESCRIPTION OF EMBODIMENTS

The present invention will be described.

The present invention is a lithium ion conductive glass material containing, in mole percent on an oxide basis, 43.5 to 49.0% of a P₂O₅ component, 0.5 to 4.0% of an Al₂O₃ component, and 47.0 to 55.0% of a Li₂O component. In other words, this lithium ion conductive glass material contains, in mole percent on an oxide basis, 43.5 to 49.0% of a P₂O₅ component, 0.50 to 4.0% of an Al₂O₃ component, and 47.0 to 55.0% of a Li₂O component, satisfying all of them at the same time.

In the following, this may also be referred to as “the lithium ion conductive glass material of the present invention.”

The content of the respective components contained in the lithium ion conductive glass material of the present invention is all in mole percent on an oxide basis unless otherwise specified. The content “in mole percent on an oxide basis” means the content of the respective components contained in the lithium ion conductive glass material of the present invention, assuming that all the oxides, complex salts, metal fluorides, and the like used as a raw material of the lithium ion conductive glass material of the present invention are decomposed and converted into oxide when melted, taking the total number of moles (total amount of substances) of the resulting oxide as 100% by mole.

### <Constituent Components>

First, the components constituting the lithium ion conductive glass material of the present invention will be described.

The P₂O₅ component is an essential component necessary for glass formation of the lithium ion conductive glass material of the present invention, and is a component that can adjust the glass transition point (Tg). It is also a component that promotes crystallization in mixing and sintering with a lithium ion conductive material at low temperature, and facilitates an increase in the density of the resulting solid electrolyte and others. Thus, the lower limit of the content of the P₂O₅ component is 43.5 mol %, preferably 43.8 mols, more preferably 44.0 mol %, further preferably 44.2 mol %, still more preferably 45.0 mol %, still further preferably 45.5 mol %, and yet more preferably 46.0 mol %. Meanwhile, since a reduction in the lithium ion conductivity and density of the solid electrolyte and others obtained by mixing and sintering with a lithium ion conductive material at low temperature due to excessive containment can be suppressed, the upper limit of the content of the P₂O₅ component is 49.0 mol %, preferably 48.5 mols, more preferably 48.3 mols, further preferably 48.0 mol %, still more preferably 47.5 mol %, still further preferably 47.0 mol %, and yet more preferably 46.5 mol %.

The Al₂O₃ component is also an essential component necessary for glass formation of the lithium ion conductive glass material of the present invention, and is a component that can adjust the melt initiation temperature (mp). It is also a component that can adjust the lithium ion conductivity of the lithium ion conductive glass material of the present invention. Thus, the lower limit of the content of the Al₂O₃ component is 0.5 mols, preferably 0.8 mole, more preferably 1.0 mol %, further preferably 1.5 mols, and still more preferably 1.7 mols. Meanwhile, since a reduction in the lithium ion conductivity of the solid electrolyte and others obtained by mixing and sintering with a lithium ion conductive material at low temperature due to excessive containment can be suppressed, the upper limit of the content of the Al₂O₃ component is 4.0 mol %, preferably 3.5 mols, more preferably 3.3 mol %, further preferably 3.0 mol %, and still more preferably 2.7 mol %.

The Li₂O component is an essential component necessary for imparting lithium ion conductivity to the lithium ion conductive glass material of the present invention. Thus, the lower limit of the content of the Li₂O component is 47.0 mol %, preferably 47.5 mols, more preferably 48.0 mol %, and further preferably 48.5 mol %. Meanwhile, from the viewpoint of increasing the chemical durability of the lithium ion conductive glass material of the present invention, the upper limit of the content of the Li₂O component is 55.0 mols, preferably 54.5 mols, more preferably 54.0 mols, further preferably 53.8 mols, still more preferably 53.5 mol %, still further preferably 53.0 mols, yet more preferably 52.5 mols, and yet further preferably 52.0 mol %.

It is more preferable for the lithium ion conductive glass material of the present invention to have a configuration in which the content of the Li₂O component is larger than the content of the P₂O₅ component, since the effect of the present invention is more easily demonstrated. At the same time, it is more preferable that the ratio of the total content of the Al₂O₃ component and Li₂O component to the content of the P₂O₅ component ((Al₂O₃ component+Li₂O component)/P₂O₅ component, molar ratio) is 1.05 or more, preferably 1.08 or more, and more preferably 1.15 or more. This upper limit is more preferably 1.30 or less, further preferably 1.28 or less, and still more preferably 1.26 or less.

Although the lithium ion conductive glass material of the present invention may have a configuration composed of the essential components described above, it may further include one or more selected from the group consisting of a SiO₂ component, a B₂O₃ component, a Nb₂O₅ component, a GeO₂ component, a La₂O₃ component, a Sc₂O₃ component, an Y₂O₃ component, a CeO₂ component, a MgO component, a CaO component, a SrO component, a ZrO₂ component, a TiO₂ component, a SnO₂ component, a V₂O₅ component, a Fe₂O₃ component, a Fe₂O₄ component, a Mn₃O₄ component, a Mn₂O₇ component, a CoO component, a Co₂O₃ component, and a Bi₂O₃ component as an optional component.

The SiO₂ component, B₂O₃ component, GeO₂ component, Nb₂O₅ component, and La₂O₃ component are all optional components that facilitate glass formation of the lithium ion conductive glass material of the present invention. Therefore, they can substitute (replace) part of the P₂O₅ component. Furthermore, the Nb₂O₅ component is also a component that can adjust the glass transition point (Tg) and melt initiation temperature (mp). In addition, the SiO₂ component can also increase the mechanical strength of the solid electrolyte and others obtained by mixing and sintering with a lithium ion conductive material at low temperature. It is suitable that the content of the SiO₂ component is preferably 5.0 mole or less, more preferably 3.0 mols or less, and further preferably 2.0 mol % or less. Then, it is suitable that the content of each of the B₂O₃ component, GeO₂ component, Nb₂O₅ component, and La₂O₃ component is preferably 9.0 mols or less, more preferably 8.0 mols or less, further preferably 5.0 mol % or less, still more preferably 3.0 mol % or less, and yet more preferably 2.0 mole or less.

The Sc₂O₃ component, Y₂O₃ component, and CeO₂ component are all optional components that can substitute (replace) part of the Al₂O₃ component, and can adjust the lithium ion conductivity of the lithium ion conductive glass material of the present invention. It is suitable that the content of each of the Sc₂O₃ component, Y₂O₃ Component, and CeO₂ Component is preferably 9.0 mol % or less, more preferably 8.0 mol % or less, further preferably 5.0 mols or less, still more preferably 3.0 mol % or less, and yet more preferably 2.0 mol % or less.

The MgO component, CaO component, and SrO component are all optional components that can substitute (replace) part of the Al₂O₃ component, and can further increase the lithium ion conductivity of the lithium ion conductive glass material of the present invention. Furthermore, they are also components that can adjust the glass transition point (Tg) and melt initiation temperature (mp). It is suitable that the content of each of the MgO component, CaO component, and SrO component is preferably 9.0 mol % or less, more preferably 8.0 mole or less, further preferably 5.0 mol % or less, still more preferably 3.0 mol % or less, and yet more preferably 2.0 mol % or less.

The ZrO₂ component, TiO₂ component, and SnO₂ component are all optional components that can impart water resistance to the lithium ion conductive glass material of the present invention. The ZrO₂ component can also contribute to improvement in the chemical durability of the lithium ion conductive glass material of the present invention. It is suitable that the content of the ZrO₂ component is preferably 0.5 mol % or more, more preferably 1.0 mole or more, and further preferably 2.0 mol % or more, since chemical durability can also be improved when the lithium ion conductive glass material of the present invention is in the form of powder. Meanwhile, it is suitable that the content is preferably 9.0 mol % or less, more preferably 8.0 mol % or less, further preferably 5.0 mol % or less, and still more preferably 3.0 mol % or less, since the melting temperature can be set lower when melting the raw materials and devitrification at the time of casting (glass lump formation) is more easily suppressed. In addition, it is suitable that the content of each of the TiO₂ component and SnO₂ component is preferably 9.0 mol % or less, more preferably 8.0 mol % or less, further preferably 5.0 mols or less, still more preferably 3.0 mol % or less, and yet more preferably 2.0 mols or less.

The V₂O₅ component, Fe₂O₃ component, Fe₂O₄ component, Mn₃O₄ component, Mn₂O₇ component, CO component, Co₂O₃ component, and Bi₂O₃ component are all optional components that can impart functionality (such as suppression of reaction with electrode active material) to the lithium ion conductive glass material of the present invention. It is suitable that the content of each of these components is preferably 9.0 mol % or less, more preferably 8.0 mol % or less, further preferably 5.0 mol % or less, still more preferably 3.0 mols or less, and yet more preferably 2.0 mols or less.

In the lithium ion conductive glass material of the present invention, it is preferable to reduce the amount of sulfur(S) as much as possible (for example, less than 1.0 mol %, preferably less than 0.1 mol %), and it is more preferable that sulfur(S) is not included. This is because reduction of the amount of the S component reduces the possibility of emission of toxic gas such as hydrogen sulfate in all-solid-state secondary batteries using the lithium ion conductive glass material of the present invention as a raw material. Furthermore, it is preferable to reduce the amount of alkali metal other than Li (for example, Na, K) as much as possible, and it is more preferable that no alkali metal other than Li is included, so as to avoid reduction of lithium ion conductivity. It is also preferable to reduce the amount of zinc (Zn), arsenic (As), antimony (Sb), and lead (Pb) as much as possible, and it is more preferable that none of them are included. This is because they are toxic substances, and zinc (Zn) can also be a component that reduces lithium ion conductivity.

Then, the lithium ion conductive glass material of the present invention, which has the components and composition as described above, is a material in a vitreous state (amorphous state). In other words, it is an oxide glass material (glass electrolyte) having lithium ion conductivity. Therefore, the lithium ion conductive glass material of the present invention is substantially free from crystal phases.

### <Physical Properties, Form>

Next, the physical properties and form of the lithium ion conductive glass material of the present invention will be described in detail.

In the lithium ion conductive glass material of the present invention, the crystallization temperature (Tc) is preferably equal to or higher than 400° C. and equal to or lower than 460° C., the glass transition point (Tg) is preferably equal to or higher than 330° C. and equal to or lower than 365° C., and the melt initiation temperature (mp) is preferably equal to or higher than 560° C. and equal to or lower than 590° C. Since it is easier to further increase the lithium ion conductivity and density of the solid electrolyte and others obtained by mixing and sintering with a lithium ion conductive material at low temperature of 700° C. or lower, it is more suitable to have a configuration that satisfies at least two or more selected from the group consisting of the three thermophysical properties described above (predetermined crystallization temperature, predetermined glass transition point, and predetermined melt initiation temperature), and in particular, it is further suitable to have a configuration that satisfies all of these three thermophysical properties.

Then, the crystallization temperature (Tc) described above is further preferably 410° C. or higher, still more preferably 420° C. or higher, and yet more preferably 430° C. or higher. Furthermore, it is further preferably 455° C. or lower, still more preferably 450° C. or lower, and yet more preferably 440° C. or lower. The glass transition point (Tg) described above is further preferably 335° C. or higher, still more preferably 338° C. or higher, and yet more preferably 340° C. or higher. Furthermore, it is further preferably 360° C. or lower, still more preferably 355° C. or lower, and yet more preferably 350° C. or lower. The melt initiation temperature (mp) described above is further preferably 562° C. or higher. Furthermore, it is further preferably 587° C. or lower, still more preferably 575° C. or lower, and yet more preferably 570° C. or lower.

Here, the crystallization temperature (Tc), glass transition point (Tg), and melt initiation temperature (mp) are all values measured by differential scanning calorimetry using TG-DTA 2000SA manufactured by Bruker. Furthermore, the crystallization temperature (Tc), glass transition point (Tg), and melt initiation temperature (mp) can all be adjusted by the composition of the aforementioned components and other factors.

In addition, the lithium ion conductivity of the lithium ion conductive glass material of the present invention that satisfies at least two or more selected from the group consisting of the three thermophysical properties described above at 25° C. in a vitreous state (the lithium ion conductivity of the glass material before mixing and sintering at low temperature) is, since it is responsible for the lithium ion conductivity in forming the interface when used for production of the solid electrolyte by mixing and sintering with a lithium ion conductive material including a predetermined crystal phase, etc., preferably 5.0×10⁻⁹ S/cm or more, more preferably 8.0×10⁻⁹ S/cm or more, and further preferably 1.0×10⁻⁸ S/cm or more. Furthermore, since it is easier to suppress densification due to excessive lithium ion conduction during mixing and sintering with a lithium ion conductive material including a predetermined crystal phase, the upper limit is preferably 5.0×10⁻⁸ S/cm or less, more preferably 4.0×10⁻⁸ S/cm or less, and further preferably 3.5×10⁻⁸ S/cm or less. Even when at least two or more selected from the group consisting of the three thermophysical properties described above are not satisfied (satisfied is one or less), it is more suitable for the lithium ion conductivity at 25° C. in a vitreous state to be within the range described above.

Then, since the form of the lithium ion conductive glass material of the present invention is a sintering auxiliary (a sintering auxiliary for low temperature sintering) or the like that is mixed with a lithium ion conductive material and sintered at low temperature of 700° C. or lower to form solid electrolyte (oxide solid electrolyte), it is suitable that its form is in the form of powder from the viewpoint of easiness in low temperature mixing and sintering and easiness in interface formation during integral sintering of an all-solid-state secondary battery. The interface formation here refers to both a triphasic interface that forms the three-dimensional structure of the electrode active material, conductive auxiliary, and solid electrolyte, and an interface among solid electrolyte materials themselves. In particular, from the viewpoints of forming an interface at a lower temperature, increasing the number of reaction interfaces, and reducing the thickness of the film of the electrolyte layer in the configuration of an all-solid-state secondary battery, it is preferable that the average particle diameter (D₉₀) of this powder is 2 μm or less (for example, equal to or more than 1 μm and equal to or less than 2 μm), or that the average particle size (D₅₀) of this powder is around 1 μm (for example, 2 μm or less, preferably 1.5 μm or less, and more preferably 1 μm or less).

Sheet forming or other methods may be used in the configuration of an all-solid-state secondary battery, but even as a material for sheet forming, it is preferable to use the lithium ion conductive glass material of the present invention in the form of powder. At that time, in consideration of weather resistance and in order to suppress re-coagulation of particles, etc., it is suitable to use powder with a maximum particle size of 200 μm or less, more preferably 150 μm or less, and further preferably 120 μm or less, and with an average particle size (D₅₀) of 100 μm or less, more preferably about 80 μm or less, specifically, a 106 μm mesh-passed product or one obtained by pulverizing it such that the final maximum particle size is 1/20 or less of the target sheet film thickness, such as one with a maximum particle size of 1 μm or less if the target sheet film thickness is 20 μm. This makes it easier to suppress the reaction with the outside air until immediately before sheet forming. To make a 106 μm mesh-passed powder form from a glass lump, a stamp mill, a ball mill, a jaw crusher, or the like may be used, although there is no particular limitation. The lower limit of the average particle size (D₅₀) is not limited, but may be 20 μm or more, or even 40 μm or more, in consideration of water resistance (dissolution in water) and other factors.

In this regard, the “maximum particle size” and the “average particle size” refer to the maximum particle size and the average particle size in terms of volume (90% size in volume cumulative distribution (D₉₀) and 50% size in volume cumulative distribution (D₅₀)) measured by a laser diffraction/scattering particle size distribution measuring device.

However, the lithium ion conductive glass material of the present invention can also be a glass lump (including not only irregularly shaped lumps, but also lumps with generally regular shapes, such as plate form). For example, it can be in the form of a lump (generally plate-like) with a length and width of 10 cm×10 cm and a thickness of about 1 cm, which is characterized by a relatively low specific surface area and therefore low reactivity, making it suited for storage. It can then be distributed in this form and pulverized or otherwise used.

The lithium ion conductive glass material of the present invention, which has the configuration as described above, has the composition of the essential components strictly adjusted as described above, and furthermore, it can also have two or more selected from crystallization temperature (Tc), glass transition point (Tg), and melt initiation temperature (mp), as well as lithium ion conductivity in a vitreous state, strictly adjusted. Therefore, it can form a solid electrolyte and others with a high density and a high lithium ion conductivity without pressurization by mixing and sintering with a lithium ion conductive material at low temperature of 700° C. or lower without pressurization (without pressurization during sintering). In other words, it can serve as a sintering auxiliary (sintering auxiliary for glass electrolyte) or the like, capable of forming solid electrolyte with a high density and a high lithium ion conductivity even when sintered at low temperature of 700° C. or lower. For example, by low temperature sintering at 700° C. or lower, even without pressurization during sintering, a solid electrolyte and others with a density of 2.45 g/cm³ or more, preferably 2.50 g/cm³ or more, and more preferably 2.55 g/cm³ or more and with a lithium ion conductivity at 25° C. of 5.0×10⁻⁵ S/cm or more, preferably 8.0×10⁻⁵ S/cm or more, and more preferably 1.0×10⁻⁴ S/cm or more can be obtained. Therefore, it is easy to mass-produce a solid electrolyte and others with a high density and a high lithium ion conductivity. Since low temperature sintering at 700° C. or lower is possible, it can also be integrally molded with materials including electrode active materials. Then, as will be described later, this can be suitably used as a coating agent (covering glass layer) for electrode active materials.

Although there is no particular limitation on the lithium ion conductive material to be used for mixing and sintering with the lithium ion conductive glass material of the present invention, in the case of preparing a solid electrolyte by mixing and sintering at low temperature of 700° C. or lower, it is suitable to use a LATP lithium ion conductive material, such as a lithium ion conductive material (such as lithium ion conductive glass ceramics) including a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi₂₋ₓSi_{y}P_{3-y}O₁₂ (0.7>x≥0.05, 0.5>y≥0). In other words, it is suitable to obtain a solid electrolyte material in which the lithium ion conductive glass material of the present invention and a lithium ion conductive material including a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi₂₋ₓSi_{y}P_{3-y}O₁₂ (0.7>x≥0.05, 0.5>y≥0) are mixed. Then, in this case, the lithium ion conductive glass material of the present invention used for mixing is preferably a powder with a maximum particle size of 200 μm or less and an average particle size (D₅₀) of 100 μm or less. In this regard, the “glass ceramics” described above means a material prepared by depositing crystal phase by heat treating a raw material, glass material (amorphous material) or a material prepared by synthesizing crystal phase by heat treating a glass material and other materials. The glass ceramics includes both a crystal phase formed by heat treatment and an amorphous phase (non-crystal phase). In short, the “glass ceramics” is a mixture of ceramics and glass.

In this lithium ion conductive material including a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi₂₋ₓSi_{y}P_{3-y}O₁₂ (0.7>x≥0.05, 0.5>y>0), x in the above formulae is more preferably 0.6 or less, further preferably 0.5 or less. Furthermore, the lower limit of this x is more preferably 0.1 or more. In addition, y in the above formula is more preferably 0.4 or less, further preferably 0.3 or less.

Furthermore, this lithium ion conductive material may also partially include lithium ion conductive crystal phases with other structures (such as LISICON type, perovskite type, and garnet type). However, even in this case, in all crystal phases included in this lithium ion conductive material (total crystal phases), the crystal phases described above account for more preferably 80% by mass or more, further preferably 90% by mass or more, still more preferably 95% by mass or more, and yet more preferably 99% by mass or more. In short, it is preferable that the crystal phases described above constitute the main crystal phase. It may also have a configuration in which the crystal phase included in this lithium ion conductive material is substantially composed of the crystal phases described above.

Moreover, in this low temperature sintering at a sintering temperature of 700° C. or lower, a layer that serves as an electrode layer of an all-solid-state secondary battery (positive electrode layer and/or negative electrode layer), an interconnector layer, and others may be integrally molded to form a member. Then, using this member, an all-solid-state secondary battery can be formed. In short, an all-solid-state secondary battery can also be formed that includes a member integrally molded by sintering materials including the solid electrolyte material described above, and a positive electrode material or negative electrode material. A known material may be used as the electrode layer or electrode material. For example, an electrode layer or electrode material for all-solid-state secondary batteries prepared by mixing an electrode active material (positive electrode active material or negative electrode active material) with a conductive auxiliary, an inorganic binder and the like, if necessary, and then sintering may be used. It is also possible to obtain an electrode layer (electrode layer including solid electrolyte) for an all-solid-state secondary battery by mixing and sintering the lithium ion conductive glass material of the present invention and a lithium ion conductive material with a positive electrode active material or a negative electrode active material at low temperature. Then, by using the lithium ion conductive glass material of the present invention as part of the solid electrolyte material and sintering it at low temperature of 700° C. or lower, decomposition of the electrode active material in the resulting all-solid-state secondary battery and a reduction in the discharge capacity can also be suppressed.

Examples of positive electrode active materials include NASICON type LiV₂(PO₄)₃, olivine type LiₓJ_{y}MtPO₄ (in which J is at least one or more selected from Al, Mg, or W, Mt is one or more selected from Ni, Co, Fe, or Mn, x satisfies 0.9≤x≤1.5 and y satisfies 0≤y≤0.2), layered oxide and spinel oxide (such as lithium manganese oxide). Examples of negative electrode active materials include oxide including a NASICON, an olivine, or a spinel crystal, rutile oxide, anatase oxide, amorphous metal oxide and metal alloy. Examples of conductive auxiliaries include a carbon compound such as plumbago (graphite), activated carbon and carbon nanotube, metal composed of at least one selected from Ni, Fe, Mn, Co, Mo, Cr, Ag, or Cu, an alloy thereof, metal such as titanium, stainless steel and aluminum, and precious metal such as platinum, gold, ruthenium and rhodium.

Moreover, as described above, the lithium ion conductive glass material of the present invention can be suitably used as a coating agent for electrode active materials. In other words, it can also be considered a lithium ion conductive glass material suited for a covering treatment on electrode active materials. Then, an electrode active material is preferably provided that has a covering glass layer formed by performing a covering treatment with the lithium ion conductive glass material of the present invention on a surface, wherein the coverage ratio of this covering glass layer on this surface is 18% or more. For example, in liquid lithium ion secondary batteries that use liquid electrolyte, the electrode active material is damaged and deteriorated at the time of desolvation during charging and discharging, and as a result, there is a problem that these liquid lithium ion secondary batteries are prone to cycle deterioration and other issues. However, the use of an electrode active material having such a covering glass layer can suppress this damage to the electrode active material. Furthermore, in all-solid-state secondary batteries, an electrode active material having such a covering glass layer can be mixed and sintered with a solid electrolyte material (a material containing lithium ion conductive material) at 700° C. or lower, making the interface formation between this electrode active material and the solid electrolyte good and lowering the interface resistance therebetween, which is suitable. As this electrode active material (positive electrode active material or negative electrode active material), those described above can be used.

Here, the surface of the electrode active material is a face arranged on the outermost side in the electrode active material. In addition, the covering treatment means a treatment to cover at least part of this surface. Therefore, this covering glass layer is arranged as the topmost layer to cover at least part of the surface of the electrode active material.

The coverage ratio of the covering glass layer formed by performing a covering treatment with the lithium ion conductive glass material of the present invention on the surface of the electrode active material can be 18% or more, which is further preferably 20% or more, still more preferably 25% or more, and yet more preferably 30% or more,

The “coverage ratio” here refers to the proportion of the region having the covering glass layer among the entire surface of the electrode active material, and specifically, it is determined as the proportion obtained by performing elemental analysis of the topmost layer of the electrode active material having the covering glass layer (the portion with a thickness of several nm to several tens of nm from the outermost side) by X-ray photoelectron spectroscopy (XPS, for example, VersaProbe II manufactured by ULVAC-PHI, Inc.), calculating, from the quantitative equivalent values (atom %: atomic percentage) of the elements obtained by this analysis, and the composition of the electrode active material and the composition of the covering glass layer (the lithium ion conductive glass material of the present invention), the sum of the quantitative equivalent values of the elements in the covering glass layer, and dividing this by the sum of the quantitative equivalent values of all elements detected. Note that, if there is an overlap between an element of the covering glass layer and an element of the electrode active material, such as oxygen, for example, the ratio of another element with the largest expected content (an element not overlapping with the electrode active material) in the composition of the covering glass layer, excluding Li, is given priority, conversion is made from the detected value of this other element and the composition (molar ratio) of the covering glass layer, and the excess amount therefrom is subtracted from the sum of the elements included in the composition of the covering glass layer. In addition, the calculation of this coverage ratio does not exclude carbon dioxide or others that are assumed to be an adsorbed gas.

When this electrode active material having a covering glass layer formed by performing a covering treatment with the lithium ion conductive glass material of the present invention on the surface is used for all-solid-state secondary batteries, its interface formation is easily made good, which is suitable. Furthermore, when this is used for liquid lithium ion secondary batteries, its cycle deterioration and other issues are easily suppressed, which is suitable. In other words, it is possible to obtain a preferred lithium ion secondary battery (an all-solid-state secondary battery or a liquid lithium ion secondary battery using liquid electrolyte) that includes this electrode active material having a covering glass layer formed by performing a covering treatment with the lithium ion conductive glass material of the present invention on the surface.

### <Method for Producing Lithium Ion Conductive Glass Material>

Next, the method for producing the lithium ion conductive glass material of the present invention will be described.

The lithium ion conductive glass material of the present invention may be produced by a usual method for producing an amorphous inorganic material, such as calcination, melting, and vitrification of inorganic materials. In short, the predetermined inorganic materials are weighed, uniformly mixed, then housed in a pot made of alumina, quartz, gold, or platinum, raised to a temperature of 750° C. to 1450° C., and held and melted at that temperature for 30 minutes to 4 hours. By casting the melted glass obtained by melting and cooling it by slow cooling or water cooling, the lithium ion conductive glass material of the present invention can be obtained. The melting temperature is not limited, and is preferably 1,000° C. or higher, more preferably equal to or higher than 1,000° C. and equal to or lower than 1300° C. The inorganic materials used for production are not limited, either, but it is preferable to use lithium phosphate (Li₃PO₄), lithium metaphosphate (LiPO₃), orthophosphoric acid (H₃PO₄), aluminum phosphate (Al(PO₃)₃), silicon oxide (SiO₂), niobium oxide (Nb₂O₅), germanium oxide (GeO₂), or the like.

The embodiments described above are only an example for facilitating understanding of the present invention and do not limit the present invention. More specifically, the components, crystal phases and the like illustrated above may be modified or improved without departing from the gist of the present invention, and the present invention of course includes the equivalent.

Hereinafter Examples of the present invention will be described, but the present invention is not limited to the following Examples, and may be modified in various ways within the technical scope of the present invention.

### EXAMPLES

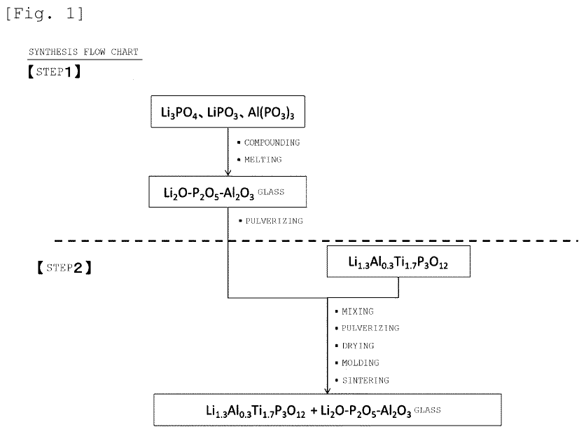

According to Step 1 of the synthesis flow chart shown in FIG. 1, a lithium ion conductive glass material (lithium ion conductive glass sintering auxiliary) was prepared. In addition, according to Step 2 of the synthesis flow chart shown in FIG. 1, a mixing and sintering test (preparation of solid electrolyte) between the lithium ion conductive glass material and a lithium ion conductive material was conducted to simulate the interface formation in an all-solid-state secondary battery. In addition, a covering test in which a covering treatment with the above lithium ion conductive glass material was performed on an electrode active material, and a charging and discharging test of a half cell using that electrode active material were also conducted.

### <Preparation of Lithium Ion Conductive Glass Material>

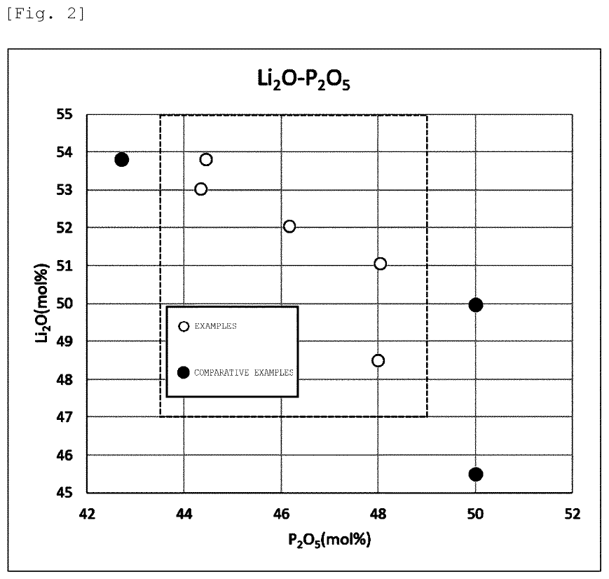

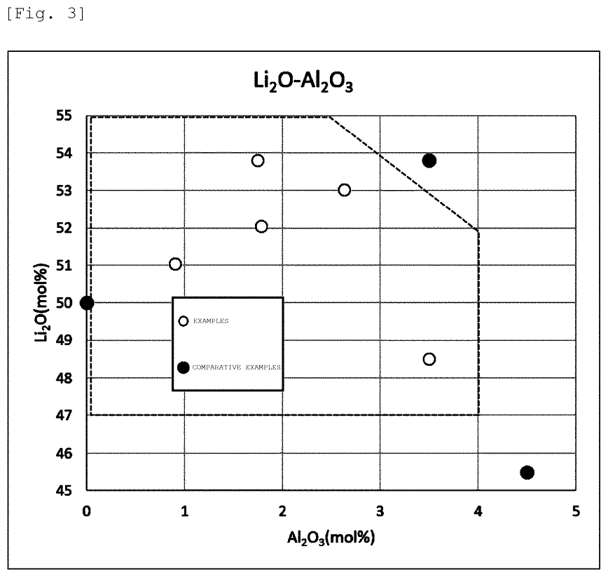

First, lithium phosphate (Li₃PO₄), lithium metaphosphate (LiPO₃), and aluminum phosphate (Al(PO₃)₃) were compounded so that the mole percent on an oxide basis was the stoichiometric ratio shown in the following Table 1. The mixture was placed in a platinum pot, and melted and vitrified with thoroughly stirring at 1,100° C. or higher, and cast on a metal cast plate to give various types of lithium ion conductive glass materials of Comparative Examples 1 to 3 and Examples 1 to 5, which were amorphous materials. Also, for lithium ion conductivity evaluation, those obtained by melting and vitrifying the materials, sandwiching them between cast plates, and forming them into a plate shape were prepared. The yield of each lithium ion conductive glass material recovered including that attached to the platinum pot was 99% by weight or more in all cases. Each lithium ion conductive glass material after casting was pulverized using a stamp mill to a mesh pass of 106 μm or less. The relationship between the P₂O₅ content (mol %) and the Li₂O content (mol %) in each lithium ion conductive glass material prepared is shown in FIG. 2, and the relationship between the Al₂O₃ content (mol %) and the Li₂O content (mol %) is shown in FIG. 3. In Examples 1 to 5, the Li₂O content was adjusted to fall within the range of 47.0 to 55.0 mol %, the P₂O₅ content within the range of 43.5 to 49.0 mols, and the Al₂O₃ content within the range of 0.5 to 4.0 mol %.

TABLE 1

| | Composition (mol %) | | |
|---|---|---|---|
| | Li₂O | P₂O₅ | Al₂O₃ |
| Comp. Ex. 1 | 50.0 | 50.0 | 0.0 |
| Comp. Ex. 2 | 53.8 | 42.7 | 3.5 |
| Comp. Ex. 3 | 45.5 | 50.0 | 4.5 |
| Ex. 1 | 53.0 | 44.3 | 2.6 |
| Ex. 2 | 52.0 | 46.2 | 1.8 |
| Ex. 3 | 51.0 | 48.1 | 0.9 |
| Ex. 4 | 53.8 | 44.45 | 1.75 |
| Ex. 5 | 48.5 | 48.0 | 3.5 |

As the basic physical property evaluation of each lithium ion conductive glass material prepared, the lithium ion conductivity and thermophysical properties were evaluated.

As for the measurement of lithium ion conductivity, a gold electrode was formed on both sides of each plate-shaped lithium ion conductive glass material as a blocking electrode using a magnetron sputtering device (SC-701HMC manufactured by Sanyu Electron Co., Ltd.); and the impedance was measured using Electrochemical Measurement System (SP300 manufactured by Biologic) at 25° C. under conditions of a frequency of 0.1 Hz to 7 MHz, an amplitude voltage of 10 mV and an open circuit voltage to calculate the lithium ion conductivity.

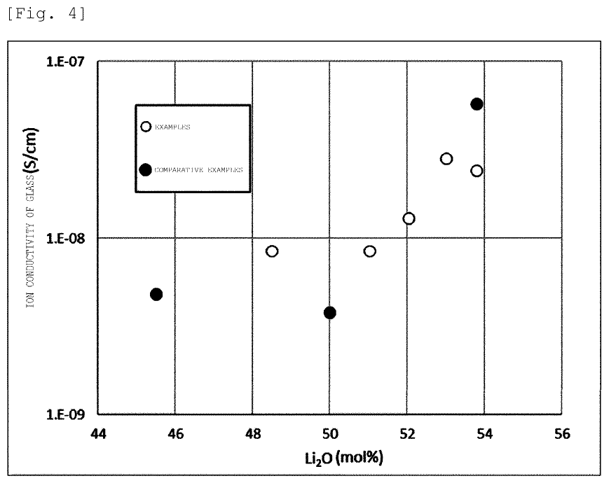

The results are shown in Table 2 below. In addition, the relationship between the Li₂O content (mol %) and the lithium ion conductivity in each lithium ion conductive glass material is shown in FIG. 4. The lithium ion conductive glass materials of Examples 1 to 5 had lithium ion conductivities in the range of 8×10⁻⁹ to 3×10⁻⁸ S/cm. On the other hand, in Comparative Examples, Comparative Example 2 had a lithium ion conductivity as high as 5.8×10⁻⁸ S/cm, while Comparative Examples 1 and 3 had lithium ion conductivities as low as less than 5×10⁻⁹ S/cm.

For thermophysical properties, differential scanning calorimetry was performed using TG-DTA 2000SA manufactured by Bruker to confirm the glass transition point (Tg), crystallization temperature (Tc), and melt initiation temperature (mp).

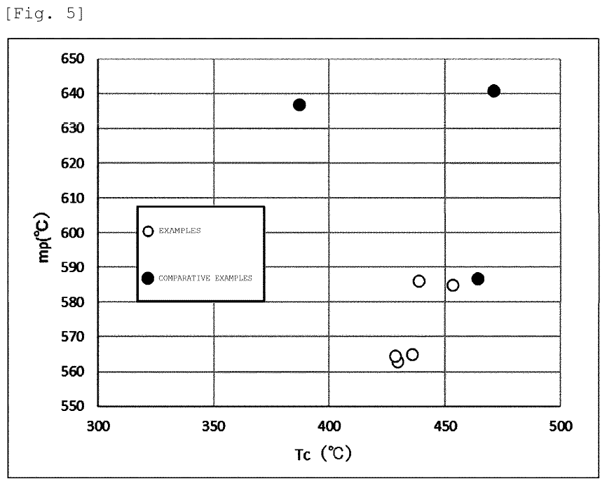

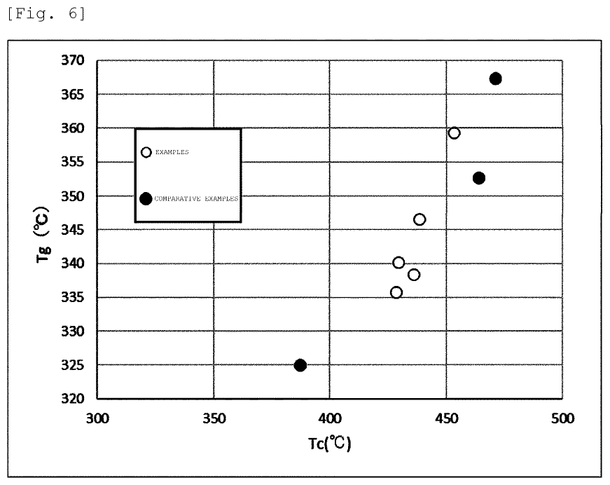

The results are also shown in Table 2 below. In addition, the relationship between the crystallization temperature (Tc) and the melt initiation temperature (mp) in each lithium ion conductive glass material is shown in FIG. 5, and the relationship between the crystallization temperature (Tc) and the glass transition point (Tg) is shown in FIG. 6. For all of Examples 1 to 5, the glass transition point (Tg) fell within the range of equal to or higher than 330° C. and equal to or lower than 365° C., the crystallization temperature (Tc) within the range of equal to or higher than 400° C. and equal to or lower than 460° C., and the melt initiation temperature (mp) within the range of equal to or higher than 560° C. and equal to or lower than 590° C.

TABLE 2

| | Lithium ion | Thermal properties (° C.) | | |
|---|---|---|---|---|
| | conductivity (S/cm) | Tg | Tc | mp |
| Comp. Ex. 1 | 3.8 × 10⁻⁹ | 325.0 | 387.2 | 637.0 |
| Comp. Ex. 2 | 5.8 × 10⁻⁸ | 352.7 | 463.9 | 586.8 |
| Comp. Ex. 3 | 4.9 × 10⁻⁹ | 367.4 | 470.9 | 640.8 |
| Ex. 1 | 2.8 × 10⁻⁸ | 346.5 | 438.6 | 586.1 |
| Ex. 2 | 1.3 × 10⁻⁸ | 340.1 | 429.7 | 562.9 |
| Ex. 3 | 8.5 × 10⁻⁹ | 338.4 | 436.0 | 564.9 |
| Ex. 4 | 2.4 × 10⁻⁸ | 335.8 | 428.6 | 564.5 |
| Ex. 5 | 8.4 × 10⁻⁹ | 359.3 | 453.3 | 584.9 |

### <Mixing and Sintering Test Between Lithium Ion Conductive Glass Material and Lithium Ion Conductive Material>

In addition, for comparison of the performance of these lithium ion conductive glass materials, a mixing and sintering test was conducted to simulate the interface formation in sintering of an all-solid-state secondary battery, as shown in Step 2 of FIG. 1, in which these lithium ion conductive glass materials (sintering auxiliaries) and a lithium ion conductive material (Li_{1.3}Al_{0.3}Ti_{1.7}P₃O₁₂: lithium ion conductive glass ceramics) were mixed and pulverized, and sintered at low temperature, preparing Comparative Examples 4 to 6, which are solid electrolytes using Comparative Examples 1 to 3 as the sintering auxiliary, respectively, and Examples 6 to 10, which are solid electrolytes using Examples 1 to 5 as the sintering auxiliary, respectively. More specifically, the solid electrolytes were prepared by the following procedure.

The lithium ion conductive glass materials of Comparative Examples 1 to 3 and Examples 1 to 5 prepared as described above and the lithium ion conductive material (Li_{1.3}Al_{0.3}Ti_{1.7}P₃O₁₂) were both pulverized to 106 μm or less. Then, they were compounded so that the proportion of the lithium ion conductive glass material was 12% by weight and the proportion of the lithium ion conductive material was 88% by weight, and 1-propanol was added thereto. The mixture was pulverized and mixed using φ 2 mm zirconia beads (YTZ beads manufactured by Nikkato Corporation) and a 500 cc zirconia pot by using a planetary ball mill under conditions of 250 rpm and 2 hours (pulverized for 5 minutes, suspended for 1 minute). The slurry was separated from the zirconia beads after pulverization with a sieve, and then the resulting slurry was dried by using a shelf dryer with solvent recovery system (manufactured by The Institute of Creative Chemistry Co., Ltd.).

The dried mixed powder described above was disintegrated using an alumina pestle and mortar to pass a 500-μm mesh, and then 1.5 g of the resultant was collected and molded using a φ 20 mm mold by applying a pressure of 20 kN to give various types of pellets for measuring lithium ion conductivity.

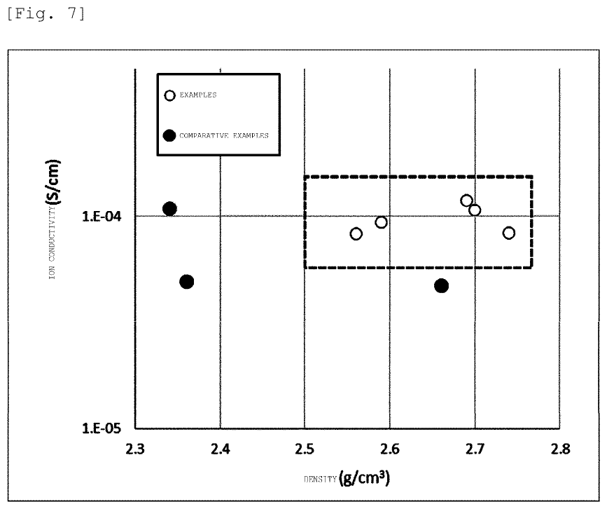

The pellets for measuring lithium ion conductivity were heat treated in ambient air at 700° C. for 1 hour to give sintered pellets, which were a solid electrolyte. Then, the lithium ion conductivity was calculated for these sintered pellets by the same method as for the lithium ion conductive glass materials described above. Furthermore, the surface of the sintered pellets was polished and dried using #800 and #2000 water proof abrasive paper and 1-propanol, and then the diameter, thickness and weight were measured using a vernier caliper, a micrometer and an electronic balance, respectively, to calculate the density. The results are shown in Table 3 below. In addition, the relationship between the lithium ion conductivity and the density in the sintered pellets is shown in FIG. 7.

TABLE 3

| | Density (g/cm³) | Lithium ion conductivity (S/cm) |
|---|---|---|
| Comp. Ex. 4 | 2.66 | 4.8 × 10⁻⁵ |
| Comp. Ex. 5 | 2.34 | 1.1 × 10⁻⁴ |
| Comp. Ex. 6 | 2.36 | 4.9 × 10⁻⁵ |
| Ex. 6 | 2.59 | 9.4 × 10⁻⁵ |
| Ex. 7 | 2.70 | 1.1 × 10⁻⁴ |
| Ex. 8 | 2.74 | 8.4 × 10⁻⁵ |
| Ex. 9 | 2.56 | 8.3 × 10⁻⁵ |
| Ex. 10 | 2.69 | 1.2 × 10⁻⁴ |

In all of the positive electrode layer, negative electrode layer, and electrolyte layer of all-solid-state secondary batteries, it is important to achieve both increasing the density to form interface and being a high lithium ion conductor to conduct lithium ions. As shown in FIG. 7, it was confirmed that Examples 6 to 10 were all within the range (generally the range surrounded by the dotted line in FIG. 7) where both a high density and a high lithium ion conductivity were achieved, compared to Comparative Examples 4 to 6.

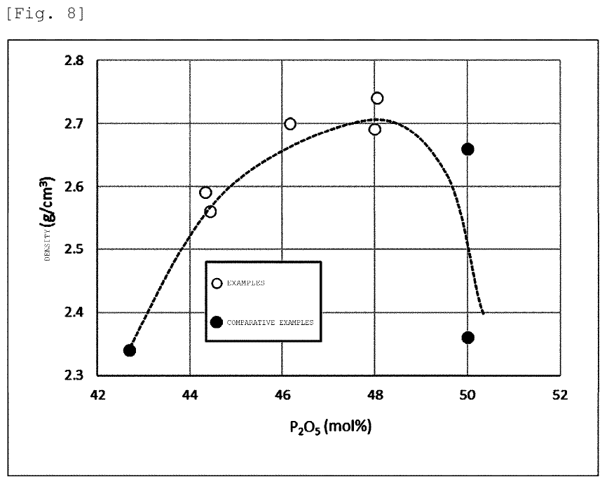

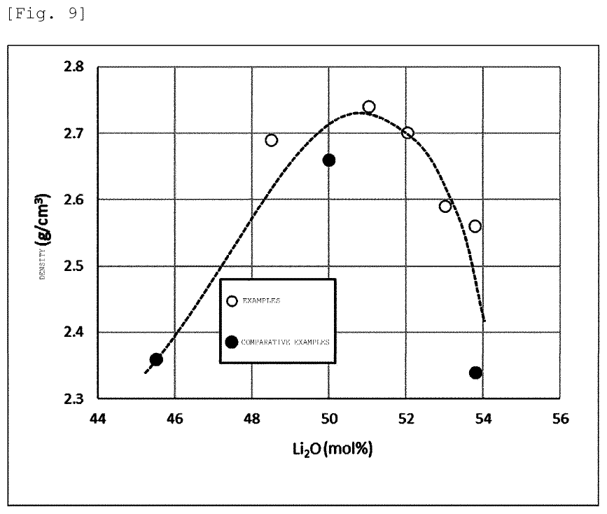

The density of the sintered pellets was confirmed to be particularly correlated with the P₂O₅ content of the lithium ion conductive glass material used, and also with the Li₂O content thereof. The relationship between the P₂O₅ content (mol %) of the lithium ion conductive glass material used to prepare the sintered pellets and the density of the sintered pellets is shown in FIG. 8, and the relationship between the Li₂O content (mol %) of the lithium ion conductive glass material used to prepare the sintered pellets and the density of the sintered pellets is shown in FIG. 9.

First, as shown in FIG. 8, the density of the sintered pellets is about 2.6 g/cm³ for a P₂O₅ content of 44 mols to 45 mol % in the lithium ion conductive glass material used. The density of the sintered pellets dropped sharply when the P₂O₅ content fell below 43.5 mol %, and the density of the sintered pellets was quite low at 2.34 g/cm³ when the P₂O₅ content was less than 43 mol % (Comparative Example 5). In other words, under these conditions, it is difficult to expect joining (interface formation) with the positive electrode material or conductive auxiliary. Meanwhile, as the P₂O₅ content increased from 44 mols to 48 mols, the density increased further, reaching a maximum density of 2.74 g/cm³ for the sintered pellets at a P₂O₅ content of 48.1 mol % (Example 8). The theoretical density of LATP is 2.88 g/cm³, the density of the glass material is 2.43 g/cm³, and the density calculated from the weight ratio is 2.88 g/cm³, which means that this filling rate is 95%, a very high density, and is expected to enable good joining (interface formation) with the positive electrode material, conductive auxiliary, and others. Then, a sample was confirmed in which the density of the sintered pellets decreased to 2.36 g/cm³ when the P₂O₅ content exceeded 50 mol % (Comparative Example 6).

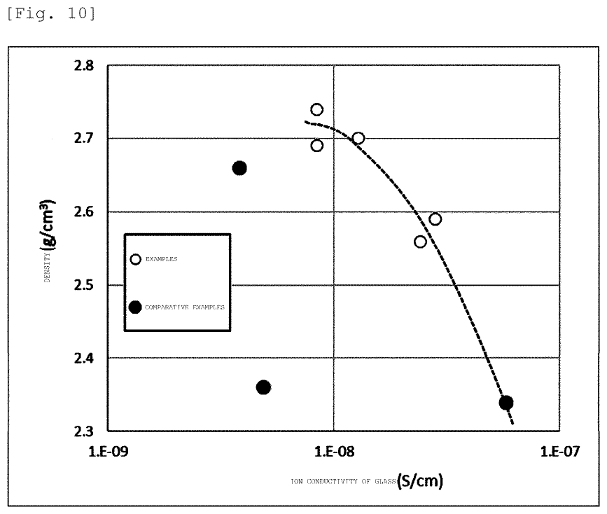

From the above, a possibility that other factors than the P₂O₅ content of the lithium ion conductive glass material used may also affect the density of the sintered pellets was considered, and thus the influence of its Li₂O content was also confirmed. As a result, as shown in FIG. 9, the density of the sintered pellets was confirmed to be as low as 2.36 g/cm³ in Comparative Example 6, where the Li₂O content of the lithium ion conductive glass material used fell below 47%. Meanwhile, the density of the sintered pellets increased when the Li₂O content of the lithium ion conductive glass material used was 47% or more, and when this Li₂O content exceeded 52%, the density of the sintered pellets showed a gradual downward trend. In Example 9 and Comparative Example 5, where the Li₂O content of the lithium ion conductive glass material used is 53.8%, their P₂O₅ content is considered to be particularly influential. Since this Li₂O content also contributes to lithium ion conductivity, the relationship between the lithium ion conductivity of the lithium ion conductive glass material used and the density of the sintered pellets was also confirmed. The results are shown in FIG. 10. When the lithium ion conductive glass material used had a lithium ion conductivity of less than 5×10⁻⁹ S/cm (Comparative Example 1 and Comparative Example 3), the density of the sintered pellets was not stable (Comparative Examples 4 and 6), but when the lithium ion conductivity was around 1×10⁻⁸ S/cm, the sintered pellets showed a high density of about 2.7 g/cm³. The density of the sintered pellets gradually decreased as the lithium ion conductivity of the lithium ion conductive glass material used further increased, and the density was as low as 2.34 g/cm³ in Comparative Example 5, which used Comparative Example 2 with the highest lithium ion conductivity. Diffusion of the material is necessary for high density, but in the NASICON crystal, there is a phenomenon in which grain boundaries grow and become coarse due to excessive grain growth, and the same phenomenon was confirmed in this test, and it was presumed that the lithium ion conductivity of the lithium ion conductive glass material used contributed to this.

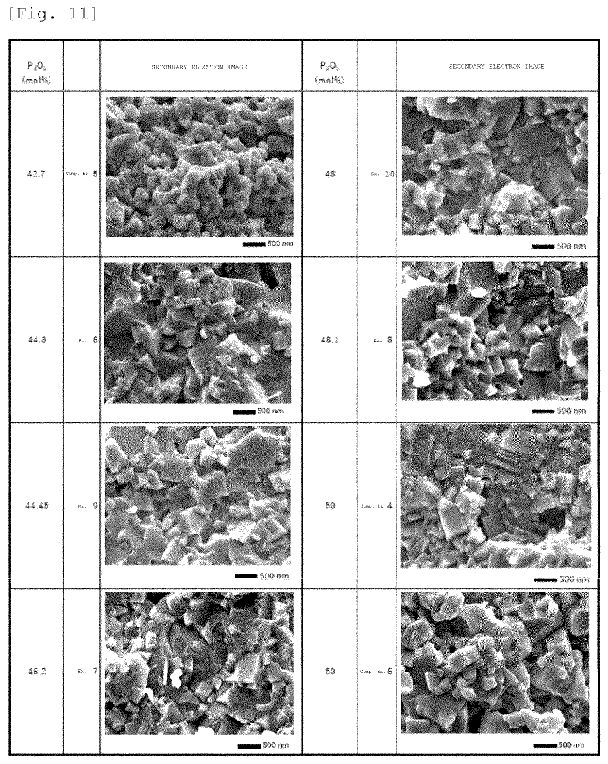

In addition, secondary electron images were checked to confirm the state of joining interface of the sintered pellets. For the observation, JSM-IT700HR manufactured by JEOL Ltd. was used. The incident voltage was 5 kV, the WD was 10 mm, the magnification was 30,000 times, and the observation was performed on a broken-out section of the sintered body. All samples were sintered pellets at 700° C. Then, the broken-out section of the sintered pellets was observed, and organized according to the P₂O₅ content of the lithium ion conductive glass material used. The results are shown in FIG. 11. In Comparative Example 5, where the P₂O₅ content of the lithium ion conductive glass material used was low, it was confirmed that each single grain was fine and the degree of grain growth and joining was low. On the other hand, grain growth and interface joining can be observed in Examples 6 to 10. In addition, the interface was relatively good in Comparative Example 4, where the P₂O₃ content of the lithium ion conductive glass material used was 50.0 mols, but in Comparative Example 6, where the lithium ion conductive glass material with the same P₂O₅ content was used, it was observed that each single grain was relatively fine and the grain-to-grain interface was separated at the grain boundary. It was presumed that the low Li₂O content of the lithium ion conductive glass material used did not allow for sufficient interface joining.

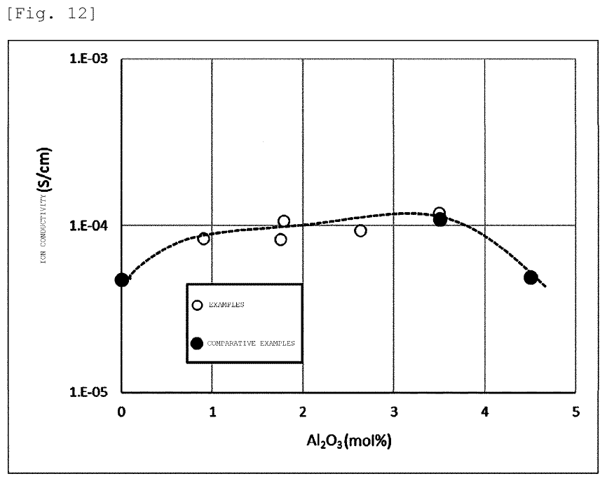

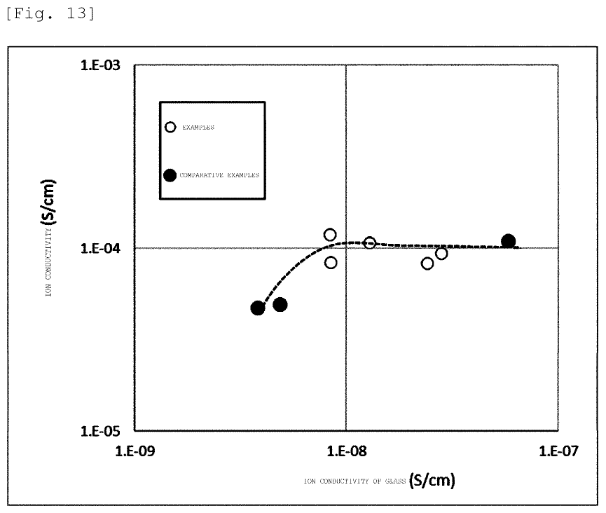

For the lithium ion conductivity of the sintered pellets, good correlation was observed with each of the Al₂O₃ content and lithium ion conductivity of the lithium ion conductive glass material used. The relationship between the Al₂O₃ content of the lithium ion conductive glass material used for the sintered pellets and the lithium ion conductivity of the sintered pellets is shown in FIG. 12, and the relationship between the lithium ion conductivity of the lithium ion conductive glass material used (ion conductivity of glass) and the lithium ion conductivity of the sintered pellets is shown in FIG. 13. Regarding the Al₂O₃ content of the lithium ion conductive glass material used, the lithium ion conductivity of the resulting sintered pellets increased when even a small amount was contained, and was more preferable at 0.5 mol % or more, but decreased when the Al₂O₃ content exceeded 4.0 mol %. The lithium ion conductivity of the lithium ion conductive glass material used and the lithium ion conductivity of the sintered pellets are highly correlated, and from the above, it is presumed that the lithium ion conductive glass material is melted during sintering and is present at the interface between LATPs, and it was confirmed that, when its lithium ion conductivity was lower than 5×10⁻⁹ S/cm, the lithium ion conductivity of the sintered pellets tended to decrease.

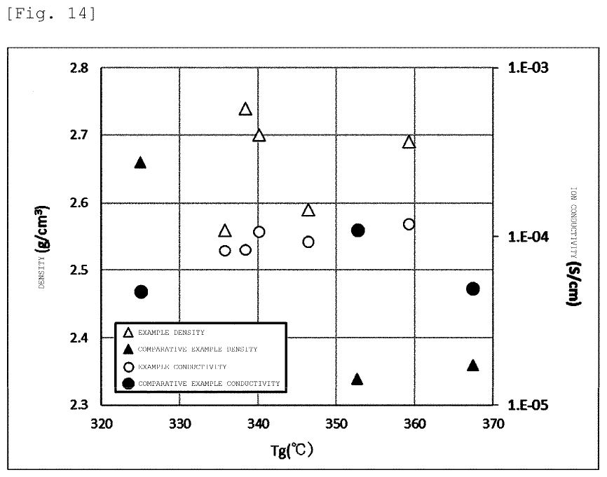

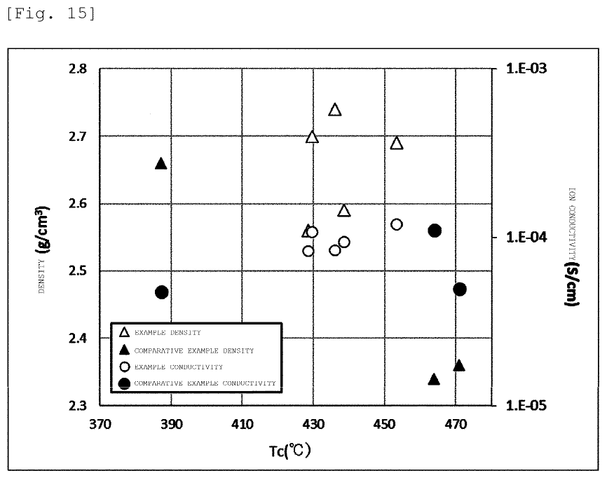

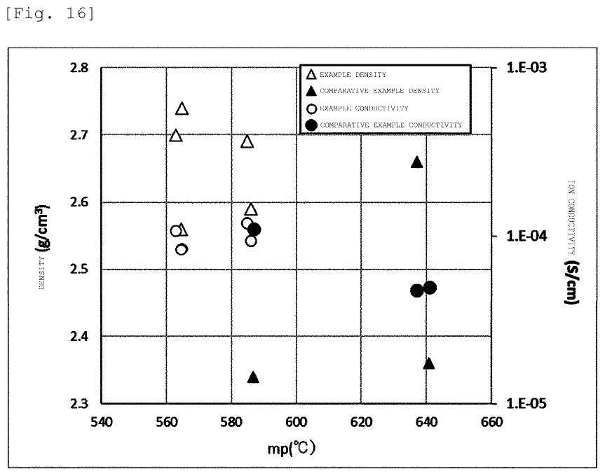

In the physical properties of the lithium ion conductive glass material used, it was confirmed that if its lithium ion conductivity was too low, the lithium ion conductivity of the sintered pellets tended to be low, and if its lithium ion conductivity was too high, the density of the sintered pellets tended to be low. Therefore, trends were also further confirmed between the thermophysical properties of the lithium ion conductive glass material used and the lithium ion conductivity and density of the sintered pellets. The results are shown in FIG. 14, FIG. 15, and FIG. 16. Examples 6 to 10, which were prepared using lithium ion conductive glass materials that satisfy all of the following ranges: glass transition point (Tg) of 330° C. to 365° C., crystallization temperature (Tc) of 400° C. to 460° C., and melt initiation temperature (mp) of 560° C. to 590° C., were confirmed to show high values for both density and lithium ion conductivity. On the other hand, in Comparative Examples, Comparative Example 4, which was prepared using a lithium ion conductive glass material with a Tg of 325.0° C., a Tc of 387.2° C., and a mp of 637.0° C., had a high density of 2.66 g/cm³, but its lithium ion conductivity was as low as 4.8×10⁻⁵ S/cm. Comparative Example 5, which was prepared using a lithium ion conductive glass material with a Tc of 463.9° C. and a lithium ion conductivity of 5.8×10⁻⁸ S/cm, had a high lithium ion conductivity of 1.1×10⁻⁴ S/cm, but its density was as low as 2.34 g/cm³. Comparative Example 6, which was prepared using a lithium ion conductive glass material with a Tg of 367.4° C., a Tc of 470.9° C., and a mp of 640.8° C., had a low density of 2.36 g/cm³, and its lithium ion conductivity was as low as 4.9×10⁻⁵ S/cm, either.

From the above, it was confirmed that, by using lithium ion conductive glass materials having the predetermined composition, and having the predetermined thermophysical properties (Tg, Tc, mp) and lithium ion conductivity as the sintering auxiliary, sintered pellets with a high density and a high lithium ion conductivity, which are necessary for the interface formation in all-solid-state secondary batteries, can be obtained.

### <Covering Test of Lithium Ion Conductive Glass Material on Electrode Active Material>

The lithium ion conductive glass materials prepared as described above were dispersed in water and then diluted with 1-propanol to prepare glass material dispersions, with which a covering treatment was performed on an electrode active material, followed by drying and heat treatment to remove the hydration water at the time of dispersion preparation, thereby conducting a covering test. More specifically, the covering test was performed by the following procedure.

### (1) Preparation of Glass Material Dispersion

5 g of each of the lithium ion conductive glass materials of Comparative Example 1, Comparative Example 2, and Example 5 was placed in a 100 ml beaker, 95 g of water and a stirrer tip were added, and the mixture was stirred for 48 hours or longer to disperse the lithium ion conductive glass material in the water. To 10 g of the solution after stirring, 30 g of 1-propanol was added, and the mixture was stirred to prepare a glass material dispersion.

### (2) Covering Treatment

In a container, 5 g of graphite (SGP25, manufactured by SEC Carbon, Ltd.: Comparative Example 7, Comparative Example 8, and Example 11) or 5 g of LiMn₂O₄ (spinel lithium manganese oxide, manufactured by Honjo Chemical Corporation: Example 12), and 20 g of the above glass material dispersion were placed, and 250 g of 5 mm beads were added. The mixture was pulverized at 1000 rpm for 5 minutes×3 sets using a kneader (Thinky Mixer (Awatori Neritaro) ADM-50, manufactured by Thinky Corporation). The suspension time between each set was 5 minutes or longer. After pulverization, the beads were separated through a SUS sieve with an aperture size of 1.7 mm, and the slurry was transferred onto a SUS vat and dried under a nitrogen atmosphere for 90 minutes.

(3) Preparation of Comparative Product without Covering Treatment

For comparison, a glass fine particle mixed sample with the same weight ratio without the covering treatment was also prepared (Comparative Example 9). For making the lithium ion conductive glass material into fine particles, a planetary ball mill (P-5, manufactured by Fritsch GmbH) was used. To 10 g of the lithium ion conductive glass material of Example 5, 30 g of 1-propanol was added, and the mixture was pulverized using φ 2 mm YTZ balls in a zirconia container at 250 rpm. Then, to 5 g of the above graphite, 1 g of the pulverized solution and 19 g of 1-propanol were added, and 250 g of 5 mm beads were further added, and the mixture was pulverized at 1000 rpm for 5 minutes×3 sets using a kneader (Thinky Mixer (Awatori Neritaro) ADM-50, manufactured by Thinky Corporation). The suspension time between each set was 5 minutes or longer. After pulverization, the beads were separated through a SUS sieve with an aperture size of 1.7 mm, and the slurry was transferred onto a SUS vat and dried under a nitrogen atmosphere for 90 minutes.

### (4) Heat Treatment

After drying, all samples were placed in an alumina mortar and heat treated at 400° C. for 10 minutes under a nitrogen atmosphere, and for the samples that had undergone the covering treatment, this heat treatment removed water bonded to the glass.

The coverage ratio of each sample prepared was analyzed for the elements in the topmost layer using X-ray photoelectron spectroscopy (XPS, manufactured by ULVAC-PHI, Inc., VersaProbe II). The X-ray source was Al-Kα (1486.6 eV), the X-ray diameter was 100 μm (25 W 15 kV), and the analysis area was a spot of φ 100 μm.

The results (detected elements and their quantitative equivalent values, and coverage ratio) and the calculation formulae for the coverage ratio from the quantitative equivalent values of the detected elements are shown in Table 4 below. Note that no correction was made for adsorbed CO₂. For Example 11, where the covering treatment with the lithium ion conductive glass material on the negative electrode active material (graphite) was performed, the coverage ratio was significantly improved and exceeded 20% compared to the mixed sample of Comparative Example 9 (where there is some lithium ion conductive glass material physically arranged on the surface of the graphite). In addition, for Example 12, where the covering treatment with the lithium ion conductive glass material on the positive electrode active material (spinel lithium manganese oxide) was performed, the coverage ratio was 58.9%. On the other hand, for Comparative Examples 7 and 8, the coverage ratio was as low as less than 18% due to the influence of the composition of the lithium ion conductive glass materials and other factors.

TABLE 4

| | Glass | Detected elements and quantitative | | | | | | | Calculation |
|---|---|---|---|---|---|---|---|---|---|
| | material | equivalent values (atom %) | | | | | | Coverage | formula for |
| | used | Li | C | O | P | Al | Mn | ratio (%) | coverage ratio |
| Comp. | Comp. | 2.4 | 86.1 | 8.9 | 2.6 | 0.0 | — | 13.9 | (Li + P + O + Al)/ |
| Ex. 7 | Ex. 1 | | | | | | | | (Li + P + O + |
| Comp. | Comp. | 3.7 | 83.0 | 10.2 | 2.9 | 0.2 | — | 17.0 | Al + C) × 100% |
| Ex. 8 | Ex. 2 | | | | | | | | |
| Ex. 11 | Ex. 5 | 3.3 | 79.1 | 13.3 | 4.0 | 0.3 | — | 20.9 | |
| Comp. | Ex. 5 | 0.4 | 93.4 | 5.2 | 1.0 | 0.0 | — | 6.6 | |
| Ex. 9 | | | | | | | | | |
| Ex. 12 | Ex. 5 | 5.4 | 6.1 | 60.5 | 16.7 | 1.3 | 10.0 | 58.9 | ((Li − Mn/2) + P + |
| | | | | | | | | | Al + (O − Mn*2))/ |
| | | | | | | | | | (Li + P + Al + C + |
| | | | | | | | | | O + Mn) × 100% |

### <Charging and Discharging Test>

To confirm the effect of coverage with the lithium ion conductive glass material on the negative electrode active material, half cells were prepared using Comparative Example 9 and Example 11, and a charging and discharging test was performed. More specifically, the test was conducted as follows.

A mixture electrode was prepared by applying a mixture (binder) of 10% polyvinylidene fluoride (PVdF) to Comparative Example 9, Example 11, or untreated graphite (SGP25) and then crimping it after drying. Using 1 mol·dm⁻³-LiPF₆/ethylene carbonate+dimethyl carbonate (volume ratio 1:1) as the electrolyte and a polyolefin separator as the separator, half cells of Comparative Examples 10 to 11 and Example 13 shown in Table 5 below were prepared. Then, the charging and discharging test was performed on them to confirm the change in charging and discharging capacity, and the reversible capacitance ratio at the first cycle ((discharge capacity/charge capacity)×100, %) was calculated.

The results are shown in Table 5 below. The reversible capacitance ratio at the first cycle of the half cell of Comparative Example 10, which used graphite to which no lithium ion conductive glass material had been added, was 90%. In addition, for the half cell of Comparative Example 11, which was prepared using Comparative Example 9, in which the lithium ion conductive glass material was simply dispersed and mixed with the negative electrode active material, there was no improvement in the reversible capacitance ratio at the first cycle. On the other hand, the half cell of Example 13, which used the graphite on which the covering treatment with the lithium ion conductive glass material had been performed, showed a remarkable improvement with a reversible capacitance ratio at the first cycle of 97%, confirming the usefulness of this covering treatment.

TABLE 5

| | Negative electrode | Reversible capacitance |
|---|---|---|
| | active material | ratio at 1st cycle (%) |
| Comp. Ex. 10 | SGP25 | 90 |
| Comp. Ex. 11 | Comp. Ex. 9 | 90 |
| Ex. 13 | Ex. 11 | 97 |

The present application claims priority to Japanese Patent Application No. 2022-099569 filed on Jun. 21, 2022, the entire disclosure of which is hereby incorporated.

1. A lithium ion conductive glass material comprising, in mole percent on an oxide basis,
43.5 to 49.0% of a P₂O₅ component,
0.5 to 4.0% of an Al₂O₃ component, and
47.0 to 55.0% of a Li₂O component.

2. The lithium ion conductive glass material according to claim 1, satisfying at least two or more selected from the group consisting of (1), (2), and (3) below, and having a lithium ion conductivity of not less than 5.0×10⁻⁹ S/cm and not more than 5.0×10⁻⁸ S/cm at 25° C. in a vitreous state:
(1) a crystallization temperature (Te) is equal to or higher than 400° C. and equal to or lower than 460° C.;
(2) a glass transition point (Tg) is equal to or higher than 330° C. and equal to or lower than 365° C.; and
(3) a melt initiation temperature (mp) is equal to or higher than 560° C. and equal to or lower than 590° C.

3. The lithium ion conductive glass material according to claim 1, which is a sintering auxiliary used for mixing and sintering with a lithium ion conductive material comprising a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi₂₋ₓSi_{y}P_{3-y}O₁₂ (0.7>x≥0.05, 0.5>y≥0), and is a powder with a maximum particle size of 200 μm or less and an average particle size (D₅₀) of 100 μm or less.

4. A solid electrolyte material formed by mixing the lithium ion conductive glass material according to claim 1 and a lithium ion conductive material comprising a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi_{2-z}Si_{y}P_{3-y}O₁₂ (0.7>x≥0.05, 0.5>y≥0).

5. An all-solid-state secondary battery, comprising a member integrally molded by sintering materials including the solid electrolyte material according to claim 4, and a positive electrode material or negative electrode material.

6. An electrode active material comprising a covering glass layer formed by performing a covering treatment with the lithium ion conductive glass material according to claim 1 on a surface, wherein a coverage ratio of the covering glass layer on this surface is 18% or more.

7. A lithium ion secondary battery comprising the electrode active material according to claim 6.

8. The lithium ion conductive glass material according to claim 2, which is a sintering auxiliary used for mixing and sintering with a lithium ion conductive material comprising a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi₂₋ₓSi_{y}P_{3-y}O₁₂ (0.7>x≥0.05, 0.5>y≥0), and is a powder with a maximum particle size of 200 μm or less and an average particle size (D₅₀) of 100 μm or less.

9. A solid electrolyte material formed by mixing the lithium ion conductive glass material according to claim 2 and a lithium ion conductive material comprising a crystal phase with a rhombohedral NASICON structure, a crystal phase of Li₁₊ₓAlₓTi₂₋ₓP₃O₁₂ (0.7>x≥0.05), or a crystal phase of Li_{1+x+y}AlₓTi₂₋ₓSi_{y}P_{3-y}O₁₂ (0.7>x≥0.05, 0.5>y≥0).

10. An all-solid-state secondary battery, comprising a member integrally molded by sintering materials including the solid electrolyte material according to claim 9, and a positive electrode material or negative electrode material.

11. An electrode active material comprising a covering glass layer formed by performing a covering treatment with the lithium ion conductive glass material according to claim 2 on a surface, wherein a coverage ratio of the covering glass layer on this surface is 18% or more.

12. A lithium ion secondary battery comprising the electrode active material according to claim 11.
